(19) United States
(12) Patent Application Publication
(10) Pub. No.: US 2024/0151352 A1
(43) Pub. Date: May 9, 2024

(54) DEVICE FOR STORING A PRESSURIZED GAS, IN PARTICULAR HYDROGEN

(71) Applicant: FAURECIA SYSTEMES D'ECHAPPEMENT, NANTERRE (FR)

(72) Inventors: Marc MORET, LA CHAPELLE SUR ERDRE (FR); Antoine De BRUX, Guérande (FR)

(21) Appl. No.: 18/280,322

(22) PCT Filed: Mar. 9, 2022
(86) PCT No.: PCT/EP2022/055956

§ 371 Date: Sep. 5, 2023

(30) Foreign Application Priority Data
Mar. 9, 2021 (FR) FR2102314

(51) Int. Cl. F17C 1/06

(52) U.S. Cl. CPC F17C 1/06; F17C 2201/0147; F17C 2201/056; F17C 2203/013; F17C 2203/0604; F17C 2203/0619; F17C 2203/0663; F17C 2205/0305; F17C 2221/012; F17C 2223/036; F17C 2270/0105; F17C 2270/0173; F17C 2270/0178; F17C 2270/0184; F17C 2270/0189

(57) ABSTRACT

A tank has a generally prismatic shape, and is capable of containing a pressurized gas. The tank comprises a composite shell, which has fibrous reinforcements and a matrix extending continuously over the six faces of the prism and delimits a sealed internal cavity comprising a plurality of open cells. The tank comprises continuous fibrous reinforcements extending into and bonded to the composite shell and further extending through the internal cavity between two opposite faces of the tank. The tank is advantageously integrated into the floor of a vehicle, in particular to the structure of an aircraft.

### CROSS-REFERENCE TO RELATED APPLICATIONS

This application is the US national phase of PCT/EP2022/055956, which was filed on Mar. 9, 2022 claiming the benefit of French Application No. 21 02314, filed on Mar. 9, 2021, which is incorporated herein by reference in its entirety.

### TECHNICAL FIELD

The disclosure relates to a transportable tank for storing a pressurized gas. The disclosure is more particularly, but not exclusively, dedicated to storage of dihydrogen under pressure, in the field of transport where hydrogen is used as fuel to produce the energy used for moving a vehicle, in the road, air, nautical, or rail fields.

However, the disclosure is also suitable for storage related to producing dihydrogen, whether static or on board.

### BACKGROUND

The storage of a pressurized gas in a transportable tank is generally carried out in a cylindrical or spherical tank, made of metal or of composite material.

Because of its low density, hydrogen gas is stored at relatively high pressures, commonly between 200 bars and 700 bars (2*10⁷ to 7*10⁷ Pa).

This type of tank from the prior art, by its shape and its volume, is difficult to integrate into a vehicle, this integration generally being done at the expense of the passenger compartment of said vehicle.

As it contains a pressurized gas, the tank must be protected from impacts that may be experienced by the vehicle, which makes its integration even more complex. In addition, the mechanical strength of said tank, which is essential to contain the gas under high pressure, poses difficulties with respect to the behavior of said vehicle in the event of an impact: said tank cannot help absorb the energy of the impact as the structure of the vehicle does when it deforms.

Thus, in a vehicle, in particular a motor vehicle, that uses hydrogen as fuel, the dihydrogen reserve is usually stored in several tanks distributed at several locations of the vehicle, which makes the management of this reserve more complex.

The pressure of 700 bars is considered to be a limit, in particular for certain conditions, but also for the bulk and weight of traditional cylindrical or spherical tanks.

According to another embodiment of the prior art, hydrogen is stored at low pressure in the form of metal hydride. This storage form is often considered to be one of the best practices according to the prior art, since it makes it possible to store hydrogen under low pressure, of the order of 10 bars (10⁶ Pa).

This storage principle is based on reversible absorption, under certain thermodynamic conditions, of hydrogen by certain metals, for example magnesium (Mg), or certain compounds.

Such tanks are filled with these metals or compounds in powder form. The tank is charged by introducing dihydrogen gas (H₂) therein, which gas is absorbed by the metal particles in an exothermic reaction under an equilibrium pressure.

The endothermic discharge is carried out by putting the tank in communication with a pressure lower than the equilibrium pressure and/or by heating said tank.

An example of hydrogen storage in hydride form is described in document WO2007011476.

This type of storage allows a relatively large number of charge/discharge cycles, but the storage capacities of such a tank degrade over time. Indeed, the hydride particles expand during charging, as hydrogen is absorbed, and shrink during discharge.

These contraction-expansion cycles lead to the compacting of the powder in the tank, particularly if these effects combine with the effects of gravity. These compacted deposits are detrimental to the storage performance of the tank and can even lead to undesirable problems, the particles thus compacted producing significant stresses as they expand during charging.

Document US 8-651-268 is an improvement to this embodiment of the prior art and describes a tank of substantially prismatic shape, able to contain a gas, in particular dihydrogen, comprising an external shell and an internal structural filling material, bonded to said external shell, in particular by gluing.

The filling material is, for example, composed of a binder comprising hydride particles capable of absorbing the gas.

Being bonded to the outer shell, the filling material participates in the mechanical strength of the tank; however, this improvement remains limited to the strength of the interface between the filler material and the outer shell. In addition, the applications of this device of the prior art are adapted to produce small tanks, with a volume less than 500 cm³ or even less than 5 cm³ and it is therefore not suitable for transporting hydrogen as an energy source for most vehicles.

This solution for storage in magnesium hydride also poses a problem of mass, as 23.6 kg of magnesium hydride (MgH₂) are needed to store 2 kg of hydrogen.

Finally, in the context of mobility-based usage, where it is necessary to have significant power at one time, the release of the hydrogen from the hydrides by mere pressure differential is too slow, and requires heating the tank to temperatures on the order of 300° C.

### SUMMARY

The disclosure aims to overcome the disadvantages of the prior art and to that end relates to a tank, having a generally prismatic shape, comprising a composite shell which has fibrous reinforcements and a matrix extending continuously over all faces of the prism and delimiting an internal cavity comprising a plurality of open cells, which tank comprises continuous fibrous reinforcements, called transverse reinforcements, extending into and bonded to the composite shell and further extending through the internal cavity between two faces of the tank, comprising a sealed liner between the external shell and the internal cavity and spacers extending between two faces of said cavity.

Thus, the tank that is the subject matter of the disclosure, by its prismatic shape, is easier to integrate into a vehicle, in particular into a floor or a wall, the transverse fiber reinforcements extending between the faces while forming a part thereof, participate in the mechanical strength of the tank, and allow it, on the one hand, to withstand high pressures, in particular compatible with hydrogen storage pressures and, on the other hand, to increase the transverse rigidity of the tank, particularly when bending, for its integration into a structure.

The outer shell can be produced by conventional manufacturing technologies in the field of composite materials.

The disclosure is advantageously implemented according to the embodiments and the variants disclosed below, which are to be considered individually or according to any technically operative combination.

According to one embodiment, the spacers are hollow and the transverse reinforcements extend inside said hollow spacers. This embodiment is more suitable for mass production.

According to another embodiment, the spacers are made of a three-dimensional nonwoven. This embodiment is more economical in particular for individual or custom manufacturing.

Advantageously, the tank according to the disclosure comprises a flange which is integral with the composite shell for fastening same. Thus, said tank is easier to integrate into a structure.

Advantageously, the tank according to the disclosure comprises a coupling comprising a part extending through the composite shell into the internal cavity.

According to one alternative embodiment, the part of the coupling extending into the internal cavity is threaded.

According to another alternative embodiment, the part of the coupling extending into the internal cavity is a conical needle.

According to yet another variant, the part of the coupling extending into the internal cavity is a ribbed needle.

These different alternative embodiments allow the coupling to enter the internal cavity of the tank without damaging the fibers.

Advantageously, the coupling is held by holding strips surrounding the tank. Said holding strips also participate in the pressure resistance of the tank.

The tank according to the disclosure is advantageously used to contain hydrogen under a pressure of between 200 bar and 1000 bar. Indeed, the structure of the tank according to the disclosure, in whose mechanical strength the cellular storage cavity participates, allows for improved use, at higher pressures than those of the prior art.

To this end, said tank is advantageously integrated into a structure, in particular into the structure of a floor in a vehicle, or in an aircraft.

### BRIEF DESCRIPTION OF THE DRAWINGS

The disclosure is disclosed below according to its preferred embodiments, which are in no way limiting, with reference to FIGS. 1 to 8 in which:

FIG. 1 shows a perspective top-down view of an embodiment of the tank according to the disclosure;

FIG. 2A schematically shows, in a defined sectional view DD [FIG. 1], the inner structure of the tank, according to one embodiment;

FIG. 2B schematically shows, in a defined sectional view DD [FIG. 1], the internal structure of the tank according to one variant of the embodiment of [FIG. 2A], comprising spacers;

FIG. 3 is a defined partial sectional view along AA [FIG. 1], of an example embodiment of a coupling, and comprises a cutaway detail view of said coupling;

FIG. 4 shows, in a defined partial sectional view BB [FIG. 1], another example embodiment of a coupling;

FIG. 5 shows a third embodiment of a coupling for the tank according to the disclosure, in a defined partial sectional view CC [FIG. 1];

FIG. 6 shows, in a defined sectional view DD [FIG. 1], a variant embodiment of the structure of the tank according to the disclosure;

FIG. 7 shows, in a perspective view, an example integration of a tank according to the disclosure into the floors of an aircraft; and

FIG. 8 shows, in a perspective view, an example integration of a tank according to the disclosure into an automobile frame.

### DETAILED DESCRIPTION

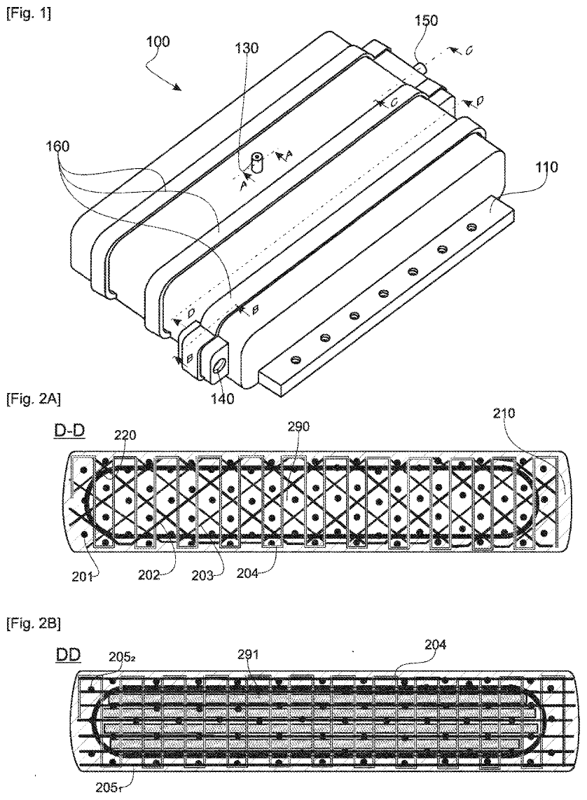

As shown in [FIG. 1], according to one embodiment, the tank (100) according to the disclosure is of generally prismatic shape, here with a rectangular base, and optionally comprises a flange (110) enabling it to be attached in any way, in particular by bolting, to any structure, in particular that of a vehicle. Said flange is advantageously integrated into the composite shell during the manufacture of the tank and is made of the same piece as said shell.

The tank (100) comprises a coupling (130, 140, 150) to allow the filling and drawing of the gas it contains.

FIG. 1 shows three exemplary embodiments of couplings on the same tank, a person skilled in the art understands that only one coupling according to any one of these embodiments is necessary, without excluding the possibility of a plurality of couplings on the same tank.

As shown in [FIG. 2A], according to one embodiment, the tank is made of a composite material with continuous fibrous reinforcements.

According to non-limiting embodiments, the fibers (201, 202, 203, 204) are carbon, glass, or aramid fibers, either alone or in any combination, so as to give said tank properties of mechanical strength and resistance to pressure, impacts and indentations, depending on the intended application.

According to this example embodiment, the fibrous network is in the form of stretchable three-dimensional fabrics of the interwoven type, commonly referred to as interlock, comprising weft fibers connecting lateral faces of the prism (201), and warp fibers, woven so that their cross-sectional orientation varies between 0° and 45° (202, 203) respectively ensuring the bond between the lateral faces as well as between the upper and lower faces of the prism. It further comprises transverse reinforcements (204) passing through the fibrous network.

Said transverse reinforcements (204) extend both between two non-contiguous faces, substantially perpendicular to said two faces, but also in the thickness of said faces, substantially parallel to these faces.

The tank comprises an external shell (210) in which the fibers are trapped in a continuous polymer matrix, of a thermoplastic or thermosetting nature, thus constituting a composite shell with continuous fibrous reinforcement. This shell (210) extends over the six faces of the prism and comprises, on its inner face, a sealed liner (220).

This sealed liner (220) delimits an internal cavity (290) in which the gas, in particular dihydrogen, is contained under pressure.

Fibers (201, 202, 203, 204) contained in the outer shell on one of the faces of the prism, where they are trapped in the matrix, extend to another face of the shell where they are also trapped in the polymer matrix, passing through the internal cavity (290) of the tank.

The fiber content in the cavity (290) is significantly lower than in the outer shell, and the fibers are impregnated with a polymer without constituting a continuous matrix, so that the internal cavity is a cellular volume, comprising a plurality of open cells delimited by said fibers.

The pressurized gas is contained in the internal cavity, the pressure tensions the fibers contained in this cavity, so that these fibers constitute transverse reinforcements and participate in the mechanical resistance of the tank

Advantageously, the fiber density is increased in the shell (210) toward the outer surface so as to improve pressure resistance.

Thus, according to one embodiment, the fiber content is between 40% and 65% in the outer shell and between 4% and 10% at the center of the internal cavity (290).

The fibers included in the outer shell and which extend through the cavity between two faces, participate in the mechanical strength of the tank both with respect to the internal pressure and external stresses, but provide a cellular volume in the cavity, able to contain a pressurized gas.

The fiber content values indicated above are indicative of a preferred embodiment relating to a compromise between the mechanical strength and capacity of the tank, but a person skilled in the art understands that the fiber content in the cavity is, depending on the intended application, advantageously raised to increase the mechanical strength to the detriment of capacity, or vice versa.

As shown in [FIG. 2B], according to one alternative embodiment, the fibrous network comprises, in the internal cavity, spacers (291) in order to generate a storage volume. In this variant, the fiber network consists of a stack of twill-type or taffeta-type fabrics (2051, 2052) in intersecting directions, connecting the lateral faces of the tank, and separated locally by said spacers.

According to alternative embodiments, the spacers (291) are, in a general designation, made up of a three-dimensional nonwoven which encompasses different types of open-cell foams, permeable mats and other media with discontinuous or cellular structures.

In the same way, the fibrous network is reinforced by transverse reinforcements (204) extending between opposite faces of the tank.

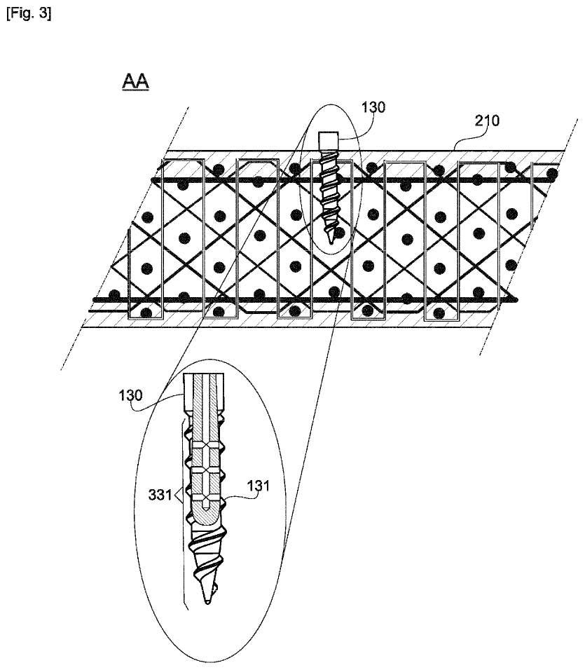

As shown in [FIG. 3], according to one embodiment, the coupling (130) comprises an outer part for connecting a duct thereto and an inner part (331) extending through the composite shell (210) of the tank into the inner cavity (290). The coupling (130) is for example made of a metallic material, which, depending on the intended application, is chosen to be resistant to the phenomenon of hydrogen embrittlement, for example a copper or aluminum alloy.

According to this example embodiment, the part (331) of the coupling extending inside the tank is threaded. This thread (131) gives the coupling a tear resistance without damaging the fibers.

Preferably, said coupling is integrated into the fibrous preform before the impregnation of the outer shell (210) by the polymer constituting the matrix.

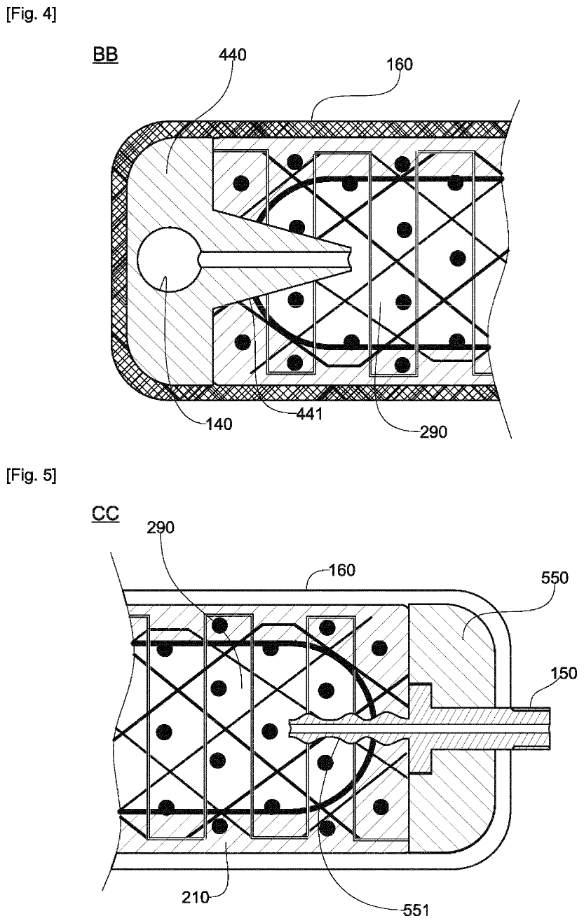

As shown in [FIG. 4], according to another embodiment, the coupling (140) is integrated into a coupling block (440) made of a metallic material, which, depending on the intended application, is chosen to be resistant to the phenomenon of hydrogen embrittlement, for example a copper or aluminum alloy.

FIG. 4 and [FIG. 1] represent a female coupling (140), but the person skilled in the art understands that a male coupling can be realized under the same principles.

The coupling block (440) comprises a needle (441), preferably conical, able to penetrate into the fibrous stack into the cavity (290) containing the gas, without damaging the fibers.

Said coupling block (440) is preferably integrated into the tank at the stage of the preform before the impregnation of the outer shell (210) by the polymer constituting its matrix, so that the fibers are not degraded by the installation of said coupling block and that sealing is ensured.

One or more holding strips (160), made of metal or preferably composite obtained by filament winding, extend around the tank and ensure the holding of the coupling block (440) against the pressurized tank.

As shown in [FIG. 5], according to another embodiment, the coupling (150) comprises a ribbed needle (551) penetrating through the outer shell (210) and the fibrous stack, to the inside of the cavity (290) of the tank. As according to the preceding embodiments, the coupling (150) is made of a metallic material, where appropriate resistant to hydrogen embrittlement, such as a copper or aluminum alloy, and is introduced into the preform of the tank before the impregnation of the outer shell by the polymer constituting the matrix.

According to this example embodiment, said coupling is held in position by a metal flange (550) which is also held by one or more holding strips (160).

As shown in [FIG. 6], according to one alternative embodiment, the tank according to the disclosure comprises an inner shell (620), comprising a plurality of hollow spacers (691), extending between two faces of said inner shell and distributed over the entire surface of these two faces.

Said hollow spacers (691) are of any shape, but are discontinuous so as not to seal off sections of the internal volume of said inner shell (620). Likewise, said spacers are not necessarily perpendicular to the walls between which they extend.

According to this embodiment, the tubular spacers (691) are cylindrical and are made from the same part as the walls of the inner shell and their bores (692) pass through said walls.

The inner shell (620) delimits a sealed internal cavity (690) able to contain a gas. Said inner shell is, according to exemplary embodiments, made of high-density polyethylene or polyamide (PA6).

By way of example, it is obtained by plastic injection techniques.

The outer shell (610) is made of a composite material with a continuous polymer and fibrous reinforcement matrix, comprising a stack of fibrous plies in a plurality of reinforcement directions, for a fiber content of between 40% and 65% of carbon, aramid, or glass fibers or any combination thereof, without these examples being limiting.

Fibers (604) extend into the outer shell (610) and between the faces thereof, passing through the inner cavity (690) of the tank into the bores (692) of the hollow spacers (691). These fibers (604) are impregnated with the polymer, which is thermosetting or thermoplastic, constituting the matrix of the outer shell, which fills the bores (692) of the hollow spacers. Thus, the hollow spacers (691) comprising fibers (604) constitute transverse reinforcements, tensioned by the pressure in the internal cavity (690) and participating in the strength and resistance of the tank. They also constitute stiffeners contributing to the rigidity and bending strength of the composite plate formed by the tank, and delimit open cells inside the cavity.

The transverse reinforcers (604) extend both between two non-contiguous faces, in the hollow spacers, substantially perpendicular to said two faces, but also in the thickness of said faces, substantially parallel to these faces.

The couplings are integrated into the tank produced according to this variant in manners similar to those described above with reference to FIGS. 3 to 5.

By way of dimensional example, regardless of the embodiment, with a carbon fiber reinforcement, a tank according to the disclosure capable of containing 4.4 kg of hydrogen at 700 bars, is in the form of a rectangular plate 1 m×0.8 m on the sides and 10 cm thick. The outer shell has a thickness of 3 to 5 mm and the inner shell or the liner, a thickness of between 1 mm and 3 mm Thus, the external volume of such a tank is 0.08 m³, which is equal to its form factor if this form factor is defined as the prismatic volume capable of containing the tank.

By way of comparison, a conventional cylindrical tank with hemispherical ends, the shell of which consists of a composite material with continuous fibrous reinforcement of carbon fibers, 9 mm thick, and with the same capacity, has a diameter of 32 cm and an external volume of 0.08 m³. However, its bulk is 25% to 40% greater than that of the tank that according to the disclosure.

Due to its shape and mechanical characteristics, the tank according to the disclosure is easily integrated into a structure intended for transporting freight or passengers, in place of structural elements, without modifying the passenger compartment or the working volume of said structure.

Indeed, since the tank according to the disclosure is, where appropriate, designed to offer, in addition to the capacity of pressurized gas, the same structural features as the structural elements that it replaces, the integration of the tank into said structure is carried out with a reduced mass contribution compared to the solutions of the prior art.

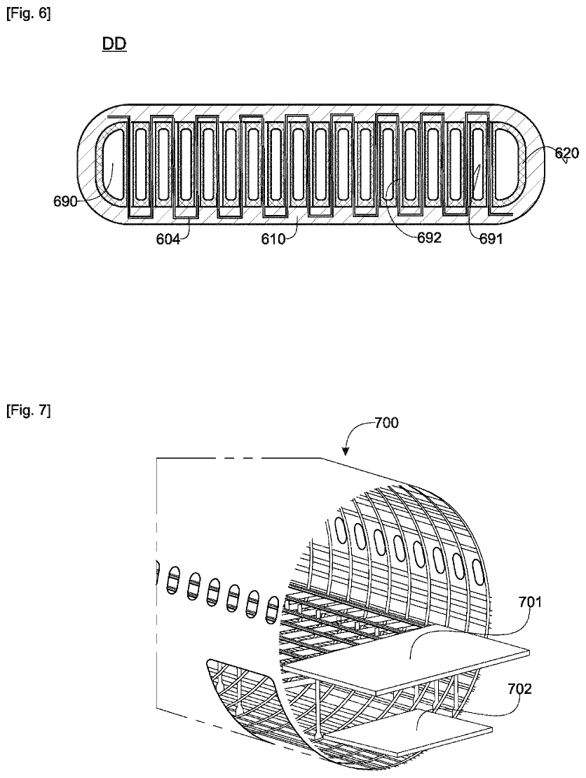

Thus, according to one example of use, the tank according to the disclosure (701, 702) is for example integrated into floors in the structure of an aircraft (700) as shown in [FIG. 7], in a passenger area or in a cargo area.

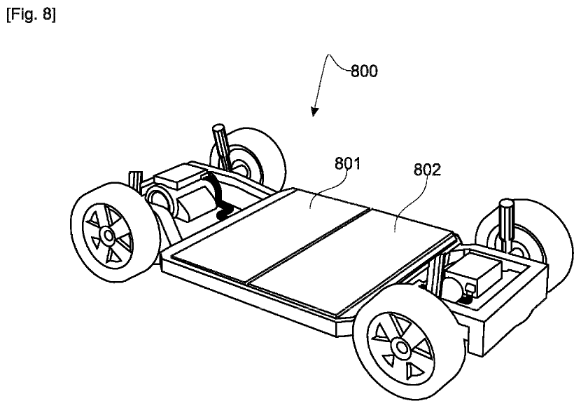

As shown in [FIG. 8], according to another example of use, one or more tanks (801, 802) according to the disclosure are integrated into the chassis (800) of an electric vehicle with a fuel cell.

These examples are not limiting and the tank that is the subject matter of the disclosure is advantageously integrated into a ship, a rail vehicle or an industrial vehicle.

1. A tank with for a pressurized gas, comprising:
a composite shell which has fibrous reinforcements and a matrix extending continuously over all faces of a prism shape of the tank, and the composite shell delimiting a sealed internal cavity comprising a plurality of open cells, comprising fibrous reinforcements extending into and bonded to the composite shell and which, in addition, extend through the sealed internal cavity between two faces of the tank, wherein the tank comprises a sealed liner between the composite shell and the sealed internal cavity, and spacers extending between two faces of the sealed internal cavity.

2. The tank according to claim 1, wherein the spacers are hollow spacers and the fibrous reinforcements extend inside said hollow spacers.

3. The tank according to claim 1, wherein the spacers are made of a three-dimensional nonwoven structure.

4. The tank according to claim 1, comprising a flange made of material with the composite shell, the flange configured to fasten the tank to a desired structure.

5. The tank according to claim 1, comprising a coupling comprising a part extending through the composite shell into the sealed internal cavity.

6. The tank according to claim 5, wherein the part of the coupling extending into the sealed internal cavity is threaded.

7. The tank according to claim 5, wherein the part of the coupling extending into the sealed internal cavity is a conical needle.

8. The tank according to claim 5, wherein the part of the coupling extending into the sealed internal cavity is a ribbed needle.

9. The tank according to claim 5, wherein the coupling is held by holding strips surrounding the tank.

10. The use of the tank according to claim 1, to store hydrogen under a pressure between 200 bar and 1000 bar.

11. The use according to claim 10, wherein the tank is integrated into a floor structure of an aircraft.

12. The use according to claim 10, wherein the tank is integrated into a floor structure of an electric motor vehicle chassis powered by a fuel cell.
